(19) United States
(12) Patent Application Publication
(10) Pub. No.: US 2025/0193601 A1
(43) Pub. Date: Jun. 12, 2025

(54) SOUND SYSTEM

(71) Applicant: MAGNADYNE CORPORATION, Compton, CA (US)

(72) Inventors: Ryan Matthew MURRAY, Elkhart, IN (US); Wen-Tsan YEH, Torrance, CA (US)

(21) Appl. No.: 18/941,693

(22) Filed: Nov. 8, 2024

Related U.S. Application Data
(60) Provisional application No. 63/606,722, filed on Dec. 6, 2023.

(51) Int. Cl. H04R 3/12

(52) U.S. Cl. CPC H04R 3/12; H04R 2201/021; H04R 2420/07; H04R 2420/09; H04R 2499/13

(57) ABSTRACT

A sound system includes a receiver and an amplifier. The receiver is configured to simultaneously receive a plurality of signals from a plurality of external devices. The amplifier is configured to amplify each of the plurality of signals, transform the plurality of signals into a plurality of amplified signals, and simultaneously transmit the plurality of amplified signals to a plurality of speakers. The sound system may be used in or on a mobile structure (e.g., recreational vehicles, boats, buses, etc.).

### CROSS-REFERENCE TO RELATED APPLICATIONS

This application claims the benefit of U.S. provisional application Ser. No. 63/606,722, filed Dec. 6, 2023, the disclosure of which is hereby incorporated in its entirety by reference herein.

### TECHNICAL FIELD

The present disclosure relates to sound systems.

### BACKGROUND

Sound systems may include amplifiers and speakers that are configured amplify signals and transmit sounds, respectively.

### SUMMARY

A sound system includes a receiver and an amplifier. The receiver is configured to simultaneously receive a plurality of signals from a plurality of external devices. The amplifier is configured to amplify each of the plurality of signals, transform the plurality of signals into a plurality of amplified signals, and simultaneously transmit the plurality of amplified signals to a plurality of speakers.

### BRIEF DESCRIPTION OF THE DRAWINGS

FIG. 1 is a front view of a sound system and a plurality of speakers;

FIG. 2 is a side view of the sound system; and

FIG. 3 is a schematic illustration of the sound system, the plurality of speakers, and a plurality of externals devices.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

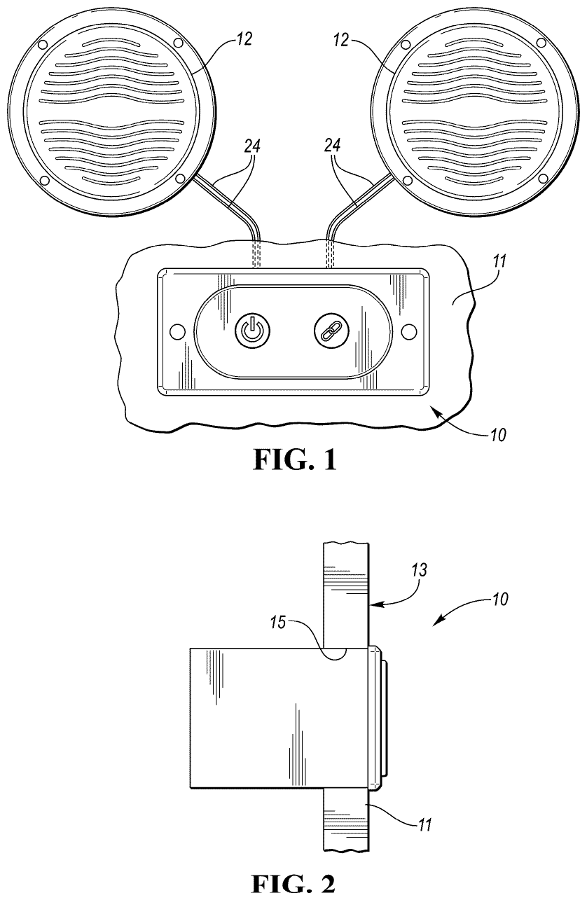

Referring to FIGS. 1-3, a sound system 10, a plurality of speakers 12, and a plurality of handheld devices or external devices 14 (e.g., a cellular phone, a smart phone, tablet, laptop computer, a radio having wireless connectivity, a digital music player, a personal digital assistant, or any other device configured to generate an audio signal and having wireless or remote network connectivity). The sound system 10 includes a receiver 16 configured to simultaneously receive a plurality of wireless signals from at least a portion of the plurality of external devices 14. The wireless signals generated by the plurality external devices 14 that are received by the receiver 16 may be Bluetooth signals, Wi-Fi signals, wireless network signals, or any other form of a wireless signal. The wireless signal may be audio signals corresponding to sound data (e.g., music, sound for a display device such as a television or tablet, audio books, etc.) that may be converted into sound via a speaker device (e.g., speakers 12).

The sound system 10, or more specifically the amplifier 18 discussed below, may also include one or more input connectors or input ports 17. The input ports 17 may establish a hardware connection between the sound system 10 and at least a portion of the plurality external devices 14. The input ports 17 may be referred to as receivers that receive signals from the external devices 14 via a hardware or wired connection. Each input port 17 is configured to receive a signal from an external device 14 (e.g., a cellular phone, a smart phone, tablet, laptop computer, a radio, a digital music player, a personal digital assistant, or any other device capable of generating an audio signal) via one or more wires or wired connections 19.

The wired connections 19 may correspond to physical wires that connect external devices 14 to the sound system 10 to transfer the signals from the external devices 14 to the sound system 10. Such physical wires comprising the wired connections 19 may have electrical connectors configured to engage the one or more input ports 17 and/or the external devices 14. Such electrical connectors may include, but are not limited to, 2.5 millimeter (mm) audio jacks, 3.5 mm audio jacks, 6.35 mm audio jacks, universal serial bus (USB) connectors (e.g., USB type A, USB type B, USB 3.0, USB Micro, USB type C, USB micro B, etc.), lighting jacks, RCA audio connectors, or any other type of connector configured to transfer signals through a physical wire. The signals transferred through the wired connections 19 may be audio signals corresponding to sound data (e.g., music, sound for a display device such as a television or tablet, audio books, etc.) that may be converted into sound via a speaker device (e.g., speakers 12).

The sound system 10 also includes an amplifier 18. The amplifier 18 is configured to amplify each of the plurality signals received by the receiver 16 and/or received by the wired connections 19 from the plurality of handheld devices or external devices 14. The amplifier 18 is then configured to transform the plurality of signals into a plurality of amplified signals. The amplifier 18 is further configured to simultaneously transmit the plurality of amplified signals to the plurality of speakers 12. The amplifier 18 may have any desirable power output. For example, the amplifier 18 may have a power output of 5 kilowatts, 10 kilowatts, 20 kilowatts, etc.

The sound system 10 may include power supply circuitry that connects the sound system 10 to a power source, such as a wall outlet or a battery. The power supply circuitry may convert alternating current (AC) to direct current (DC) if the power supply circuitry is connected to AC power source (e.g., a wall outlet). The power supply circuitry may operate the sound system 10 at a designated voltage or within a designated voltage range (e.g., 12 volts). The sound system 10 may be configured to link wirelessly or via wired connections to other sound systems (e.g., a system identical to sound system 10), which increases the number amplifiers 18, increases the number available connections between the amplifiers 18 and external devices 14, and increases the number available connections between the amplifiers 18 and speakers of such a combined system.

The sound system 10 may further include a transmitter 20 that is connected to the amplifier 18. The transmitter 20 is configured to wirelessly transmit at least a portion the plurality of amplified signals from the amplifier 18 to at least a portion of the plurality of speakers 12. The transmitter 20 may be configured to transmit at least a portion of the amplified signals to a different speaker 12 or to a different subset of speakers of the plurality of speakers 12. The transmitter 20 may be configured to direct the amplified signals from the amplifier 18 to the speakers 12 via Bluetooth signals, Wi-Fi signals, wireless network signals, or any other form of a wireless signal, but preferably via Bluetooth signals. The receiver 16 and transmitter 20 may be separate elements as illustrated or may be a combined component that performs the functions of both the receiver 16 and transmitter 20. Such a combined component that performs the functions of both the receiver 16 and transmitter 20 may be referred to as a transceiver.

The sound system 10, or more specifically the amplifier 18, may also include one or more output connectors or output ports 22. The output ports 22 may establish a hardware connection between the sound system 10, or more specifically the amplifier 18, and at least a portion of the plurality of speakers 12. The output ports 22 may be referred to as transmitters that transmit signals to the speakers 12 via a hardware or wired connection. The output ports 22 are configured to transmit at least a portion of the amplified signals from the sound system 10, or more specifically from the amplifier 18, to at least a portion of the plurality of speakers 12 via one or more wires or wired connections 24. The output ports 22 may be configured to transmit at least a portion of the amplified signals to a different speaker 12 or to a different subset of speakers of the plurality of speakers 12.

The wired connections 24 may correspond to physical wires that connect the sound system 10, or more specifically the amplifier 18, to at least a portion of the plurality of speakers 12 to transfer at least a portion of the amplified signals from the amplifier 18 to at least a portion of the plurality of speakers 12. Such physical wires comprising the wired connections 24 may have electrical connectors configured to engage the one or more output ports 22 and/or the speakers 12. Such electrical connectors may include, but are not limited to, 2.5 millimeter (mm) audio jacks, 3.5 mm audio jacks, 6.35 mm audio jacks, universal serial bus (USB) connectors (e.g., USB type A, USB type B, USB 3.0, USB Micro, USB type C, USB micro B, etc.), lighting jacks, RCA audio connectors, or any other type of connector configured to transfer signals through a physical wire. The signals transferred through the wired connections 24 may be audio signals corresponding to sound data (e.g., music, sound for a display device such as a television or tablet, audio books, etc.) that may be converted into sound via a speaker device (e.g., speakers 12).

The signals of each external device 14 may be directed to a different speaker 12 or to a different subset of speakers 12 via the transmitter 20 or via the output ports 22, such that each external device 14 ultimately dictates the audio output of a different speaker 12 or to different subset of speakers 12. Each subset of speakers 12 may be referred to as a speaker zone. The amplifier 18 is not limited to three wireless speaker connections, three wired speaker connections, and two speaker zones, but may include any number of connections (e.g., up to ninety-nine connections) between any number of external devices 14 and any number of speakers 12, where the speakers 12 are configured according to any number of designated subsets of speakers or speaker zones.

The sound system 10 may include a controller 26. The controller 26 may be programmed, to link each external device 14 to one of the speakers 12 or to a subset of the plurality of speakers 12 via the amplifier 18 and through either the transmitter 20 or the output ports 22. The subset of speakers 12 may be designated within an algorithm or control logic programmed into the controller 26. Alternatively, a software application may be downloaded onto the external devices 14 that allows the user to communicate with the controller 26 wirelessly through the receiver 16 and transmitter 20 or the wired connection 19 to access the available speakers 12 that are connected to the sound system 10, and to select one or more of the speakers to set up a desired subset of speakers or speaker zone (e.g., the subset of speakers or speaker zones may be configured or changed by an end user that accesses controller 26 of the sound system 10 via the software application on the external devices 14).

The controller 26 may be provided with an operating system including an application programming interface (API) to communicate with modem application software. The modem application software may access an embedded module or firmware on the Bluetooth transceiver (e.g., the combined receiver 16 and transmitter 20) to complete wireless communication with a remote BLUETOOTH transceiver (such as that found in an external device 14). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication and may be utilized by the sound system 10.

The controller 26 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 26 in controlling the sound system 10.

Control logic or functions performed by the controller 26 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based controller, such as controller 26. Of course, the control logic may be implemented in software, hardware, or a combination of software and hardware in one or more controllers (e.g., controller 26 and controllers on the external devices 14) depending upon the particular application. When implemented in software, the control logic may be provided in one or more computer-readable storage devices or media having stored data representing code or instructions executed by a computer to control the sound system 10. The computer-readable storage devices or media may include one or more of a number of known physical devices which utilize electric, magnetic, and/or optical storage to keep executable instructions and associated calibration information, operating variables, and the like.

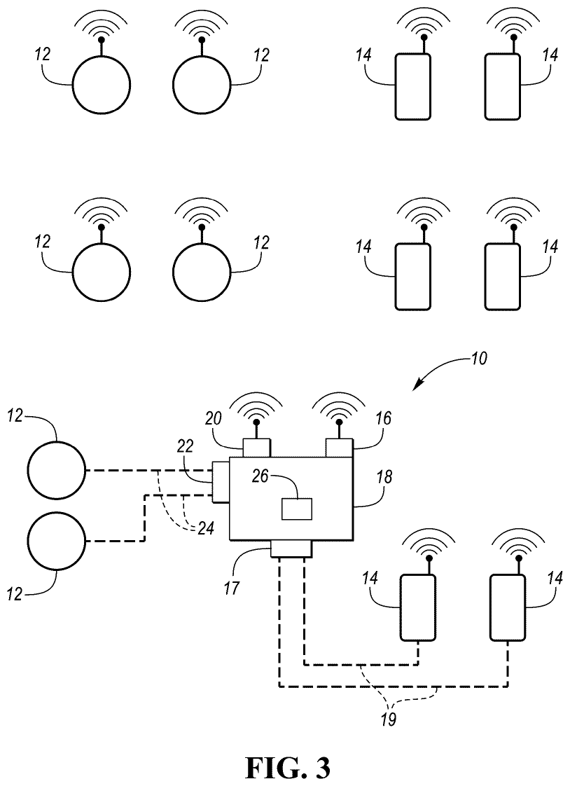

The sound system 10 (including the receiver 16, the input ports 17, the amplifier 18, the transmitter 20, the output ports 22, and/or the controller 26) may be used in or on a mobile structure 13 (e.g., recreational vehicles, boats, buses, etc.). The sound system 10 (including the receiver 16, the input ports 17, the amplifier 18, the transmitter 20, the output ports 22, and/or the controller 26) may be mounted using one or more brackets to mount the sound system 10 to a wall 11 or other surface of a mobile structure 13 (e.g., recreational vehicles, boats, buses, etc.). The sound system 10 (including the receiver 16, the input ports 17, the amplifier 18, the transmitter 20, the output ports 22, and/or the controller 26) may be mounted within an orifice 15 defined by a wall 11 or other surface of a mobile structure 13 (e.g., recreational vehicles, boats, buses, etc.). Such a wall 11 that the sound system is secured to may be an internal wall or an external wall of a mobile structure 13 (e.g., recreational vehicles, boats, buses, etc.). The number of external devices 14 and the number of available speakers 12 may be limited to the number of speakers 12 on such mobile structure 13. The speaker zones may be predesignated based on different areas or spaces within a mobile structure 13. Additional speakers, however, may be brought on to such a mobile structure 13 and linked to the sound system 10. The number of speakers 12 and external devices 14 illustrated in FIG. 3 may include any number of speakers 12 and any number of external devices 14. Each of the speakers 12 and external devices 14 that are in wireless communication with the sound system 10 may also include components for wireless communication, such as a transceiver.

In one or more embodiments, the sound system is a self-contained Bluetooth receiver connected to an internal amplifier in a wall-mounted device used in a mobile structure. The sound system may multi-link pair up to 100 similar Bluetooth portable speaker devices. The Bluetooth devices may pair together or separate pair independently and pair to different source devices. The device may be controlled through a source device via Bluetooth connection or via a phone application.

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A sound system comprising:
a receiver configured to simultaneously receive a plurality of signals from a plurality of external devices; and
an amplifier configured to (i) amplify each of the plurality of signals, (ii) transform the plurality of signals into a plurality of amplified signals, and (iii) simultaneously transmit each of the plurality of amplified signals to a different subset of a plurality of speakers.

2. The sound system of claim 1 further comprising a transmitter, wherein the transmitter is (i) connected to the amplifier and (ii) configured to wirelessly transmit at least a portion of the plurality of amplified signals from the amplifier to at least a portion of the plurality of speakers.

3. The sound system of claim 2, wherein the transmitter is configured to transmit each signal of the at least a portion of the plurality of amplified signals to a different speaker of the plurality of speakers.

4. The sound system of claim 1, wherein the amplifier includes output ports, and wherein the output ports are configured to transmit at least a portion of the plurality of amplified signals from the amplifier to at least a portion of the plurality of speakers via wires.

5. The sound system of claim 4, wherein the output ports are configured to transmit each signal of the at least a portion of the plurality of amplified signals to a different speaker of the plurality of speakers.

6. The sound system of claim 1, wherein the receiver is configured to receive the plurality of signals wirelessly.

7. The sound system of claim 1, wherein the receiver is configured to receive the plurality of signals via wires.

8. The sound system of claim 1, wherein the amplifier and the receiver are mounted to a wall.

9. The sound system of claim 1, wherein the amplifier and the receiver are mounted to a wall of a mobile structure.

10. The sound system of claim 9, wherein the mobile structure is a recreational vehicle.

11. The sound system of claim 9, wherein the mobile structure is a boat.

12. The sound system of claim 9, wherein the mobile structure is a bus.
